(19) United States
(12) Patent Application Publication
(10) Pub. No.: US 2019/0073449 A1
(43) Pub. Date: Mar. 7, 2019

(54) Computer implemented system for providing health care management

(71) Applicant: SRM University, Chennai (IN)

(72) Inventors: Santhana Karunanidhi Lakshmi, Chennai (IN); Marakanam Srinivasan Umashankar, Chennai (IN); Arumugam Porselvi, Chennai (IN)

(21) Appl. No.: 15/822,987

(22) Filed: Nov. 27, 2017

(30) Foreign Application Priority Data
Sep. 5, 2017 (IN) 201741031344

(51) Int. Cl. G06F 19/00; G06F 17/30

(52) U.S. Cl. CPC G06F 19/3431; G06F 19/345; G06F 17/30029; G06F 17/30952; G06F 19/3418

(57) ABSTRACT

The present disclosure relates to the field of health care management. The envisaged system is user friendly and assists the users in avoiding various chronic diseases. The system is configured to receive values corresponding to a plurality of health parameters, a plurality of anthropometric parameters, and a plurality of lifestyle parameters, from a registered user, by means of a user interface. The system is further configured to predict the risk of developing at least one disease by comparing the above mentioned parameters with a standard range of values of the plurality of health parameters, the plurality of anthropometric parameters, and the plurality of lifestyle parameters. Furthermore, the system is configured to provide prevention details to the user for preventing the predicted at least one disease.

### FIELD

The present disclosure relates to the field of health care management.

### BACKGROUND

Poor lifestyle choices of an individual, i.e., smoking, consumption of alcohol, diet, lack of physical activity are key contributors in the development and progression of preventable chronic diseases which includes obesity, diabetes, hypertension, cardiovascular disease, and the like.

Typically, a person suffering from any one of the above mentioned chronic diseases might not only require proper medical treatment and periodic monitoring to minimize the adverse effects of the disease, but also require to be adequately educated to enable him/her to manage the disease appropriately. Moreover, in order to reduce the overall expense and frequent visits to a medical practitioner, the person is required to make certain lifestyle changes, learn new behaviours and skills, and monitor their own health parameters at frequent intervals.

Conventional, health care management systems mainly focus on providing treatment for various preventable chronic diseases rather than providing preventive measures and/or educating the person to avoid attracting these preventable chronic diseases.

Therefore, there is felt a need for a computer implemented system for providing health care management that alleviates the above-mentioned drawbacks of the conventional systems.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a computer implemented system for providing health care management, which is user friendly.

Another object of the present disclosure is to provide a computer implemented system for providing health care management, which keeps the track of users BMI and BMR.

Still another object of the present disclosure is to provide a computer implemented system for providing health care management, which assists the users in avoiding chronic diseases.

Other objects and advantages of the present disclosure will be more apparent from the following description, which is not intended to limit the scope of the present disclosure.

### SUMMARY

The present disclosure envisages a computer implemented system for providing health care management. The system comprises a registration module, a user interface, a computation unit, a repository, a database, a comparator and selector module, and a risk prediction module. The registration module is adapted to register a user. The user interface is configured to enable the user to access the system. The user interface is further configured to receive, from the user, values corresponding to a plurality of health parameters, a plurality of anthropometric parameters, and a plurality of lifestyle parameters. In an embodiment, the plurality of health parameters is selected from the group consisting of blood pressure, blood sugar level, haemoglobin level, glycosylated haemoglobin (HbA1c), lipid profile, serum creatinine level, proteinuria, and micro albuminuria.

The computation unit is configured to receive the values corresponding to the plurality of anthropometric parameters, and is further configured to compute body mass index (BMI), diet calorie calculation (DCC), exercise calorie calculation (ECC), and basal metabolic rate (BMR) of the user, based on the values of the plurality of anthropometric parameters. The repository is configured to receive and store the values of the plurality of health parameters, values of the plurality of lifestyle parameters, and the computed values of BMI, DCC, ECC, and BMR.

The database is configured to store a set of disease records, wherein each disease record, of the set of disease records, is associated with a standard range of values for the plurality of health parameters, a standard range of values for BMI, a standard range of values for DCC, a standard range of values for ECC, and a standard range of values for BMR.

The comparator and selector module is configured to cooperate with the repository and the database. The comparator and selector module is further configured to compare:
the values of each of the plurality of health parameters with the standard range of values for each of the plurality of health parameters to select a first subset of disease records from the set of disease records;
the computed value of BMI and DCC with the standard range of values for BMI and DCC respectively to select a second subset of disease records from the set of disease records; and
the computed value of BMR and ECC with the standard range of values for BMR and ECC respectively to select a third subset of disease records from the set of disease records.

The risk prediction module is configured to predict the risk of developing at least one disease, from the set of disease records, based on the first set of disease records, the second set of disease records, and the third set of disease records.

In an embodiment, the database is configured to store a lookup table having prevention details corresponding to each of the disease record. In another embodiment, the system includes a crawler and extractor configured to crawl through the lookup table and extract the prevention details corresponding to the predicted at least one disease. In still another embodiment, the prevention details are in the form of text, audio, image, video, or any combination thereof.

In yet another embodiment, the prevention details, extracted by the crawler and extractor, are displayed on at least one handheld device, associated with user, or on a publically launched viewable touch screen monitors, which is communicatively coupled with the system.

In an embodiment, the system includes a record generation module. The record generation module is configured to generate a record corresponding to each of the user, wherein the record includes drug allergies, present medication, the value of the plurality of health parameters, values of the plurality of lifestyle parameters, the computed values of BMI, ECC, DCC, and BMR, and the predicted at least one disease. In another embodiment, the record corresponding to the user is accessed by a remote terminal, associated with at least one clinical pharmacist. The at least one clinical pharmacist assesses and provide results on adverse drug interaction, drug—drug interactions, and drug food interactions. The remote terminal is communicatively coupled to the system.

In another embodiment, the computation unit includes a lifestyle assessment calculator, a diet calorie calculator, an exercise calorie calculator, and a daily calorie calculator.

The present disclosure further envisages a computer implemented method for providing health care management. The method for providing health care management comprises the following steps of:
registering a user, using a registration module;
receiving, from the user, values corresponding to a plurality of health parameters, a plurality of anthropometric parameters, and a plurality of lifestyle parameters;
receiving, by a computation unit, the values corresponding to the plurality of anthropometric parameters;
computing, by the computation unit, body mass index (BMI), diet calorie calculation (DCC), exercise calorie calculation (ECC), and basal metabolic rate (BMR) of the user, based on the values of the plurality of anthropometric parameters;
receiving, by a repository, the values of the plurality of health parameters, values of the plurality of lifestyle parameters, and the computed values of BMI, ECC, DCC, and BMR;
storing, in the repository, the values of the plurality of health parameters, values of the plurality of lifestyle parameters, and the computed values of BMI, ECC, DCC, and BMR;
storing a set of disease records, in a database, wherein each disease record, of the set of disease records, is associated with a standard range of values for the plurality of health parameters, a standard range of values for BMI, a standard range of values for DCC, a standard range of values for ECC, and a standard range of values for BMR;
comparing, by a comparator and selector module,
   the values of each of the plurality of health parameters with the standard range of values for each of the plurality of health parameters, and selecting a first subset of disease records from the set of disease records;
   the computed value of BMI and DCC with the standard range of values for BMI and DCC respectively, and selecting a second subset of disease records from the set of disease records; and
   the computed value of BMR and ECC with the standard range of values for BMR and ECC respectively, and selecting a third subset of disease records from the set of disease records;
   and
predicting, by a risk prediction module, the risk of developing at least one disease, from the set of disease records, based on the first set of disease records, the second set of disease records, and the third set of disease records.

### BRIEF DESCRIPTION OF ACCOMPANYING DRAWING

A computer implemented system for providing health care management, of the present disclosure will now be described with the help of the accompanying drawing, in which:

FIG. 1 illustrates a block diagram of a computer implemented system for providing health care management; and

FIG. 2A-2B illustrate a flowchart depicting a method for providing health care management.

### LIST OF REFERENCE NUMERALS USED IN DETAILED DESCRIPTION AND

DRAWING

### 100—System

102—User interface
104—Registration module
106—Computation unit

### 108—Repository

### 110—Database

112—Comparator and Selector module
114—Risk prediction module

### DETAILED DESCRIPTION

The present disclosure envisages a computer implemented system for providing health care management, which provides a user friendly platform. The computer implemented system is configured to provide health care counselling, prevention details for chronic diseases, probable treatments for chronic diseases, and the like, to the users. Further, the computer implemented system also facilitates the user to perform their lifestyle assessment.

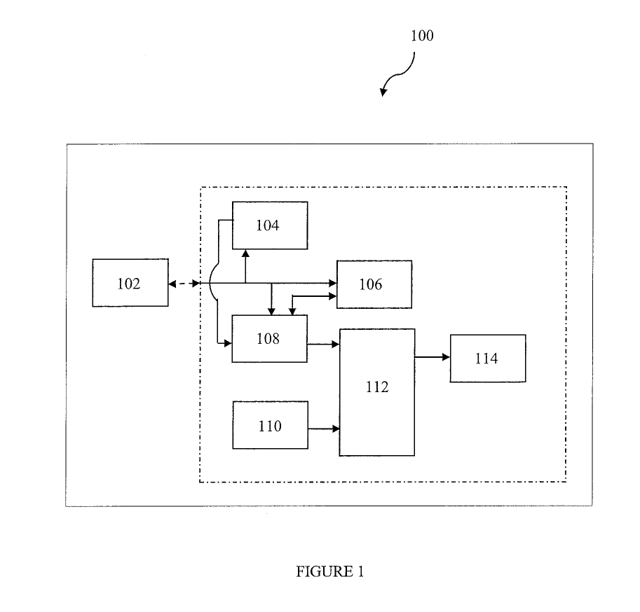

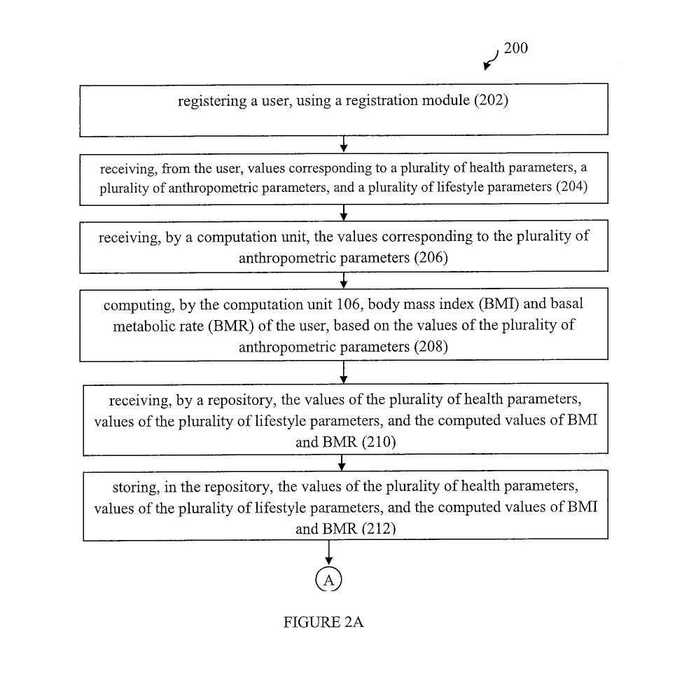

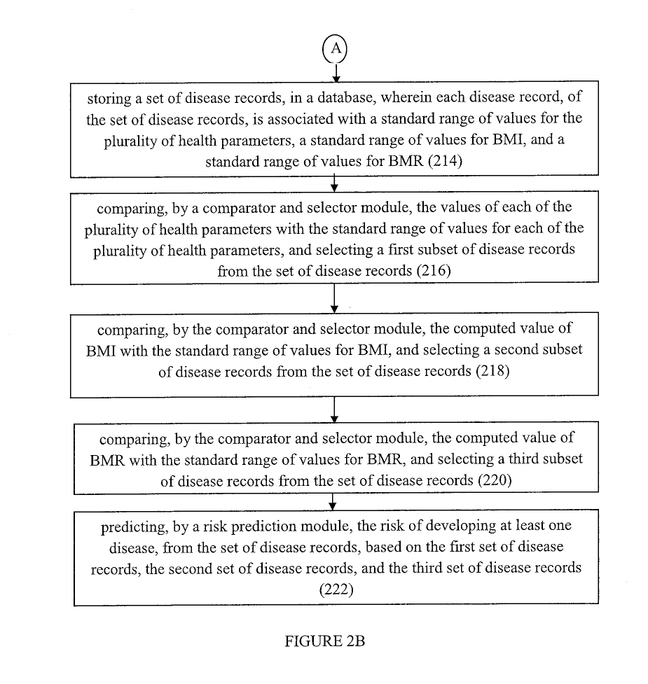

A computer implemented system 100 (hereinafter referred as “system 100”) for providing health care management, of the present disclosure, is now described with reference to FIG. 1 and FIG. 2A-2B. FIG. 1 illustrates a block diagram of the computer implemented system 100. FIG. 2A-2B illustrates a flowchart depicting a method 200 for providing health care management.

The present disclosure envisages the computer implemented system 100 for providing health care management. The system 100 comprises a registration module 104, a user interface 102, a computation unit 106, a repository 108, a database 110, a comparator and selector module 112, and a risk prediction module 114.

The registration module 104 is adapted to register the users. The registration module 104 is configured to register the users by accepting their details and storing the details in the repository 108. The registration module 110 is configured to accept information related to the user by means of the user interface 102. The information related to the user includes his/her personal details like valid email ID, contact details, postal code, gender, age, and the like. Once the personal details are accepted, a consumer profile is created in the repository 108, which includes these details of the user.

The user interface 102 is configured to enable the user to access the system 100. In an embodiment, the user is required to furnish his/her valid email ID and contact details for logging into and/or accessing the system 100. Further, upon successfully accessing the system 100, the user interface 102 prompts the user to provide values corresponding to a plurality of health parameters, a plurality of anthropometric parameters, and a plurality of lifestyle parameters. In an embodiment, the user interface 102 is provided on a handheld device or on a remote terminal.

In an embodiment, the handheld device is selected from the group consisting of a mobile, a cellular device, a personal digital assistant (PDA), a laptop, and a computing device.

In another embodiment, the remote terminal is selected from the group consisting of a mobile, a cellular device, a personal digital assistant (PDA), a laptop, a desktop, a computing device, and a publically launched viewable touch screen monitors.

In an embodiment, the plurality of health parameters is selected from the group consisting of blood pressure, blood sugar level, haemoglobin level, glycosylated haemoglobin (HbA1c), lipid profile, serum creatinine level, proteinuria, and micro albuminuria.

In another embodiment, the plurality of anthropometric parameters is selected from the group consisting of height, weight, waist size, hip size, and the like.

In still another embodiment, the plurality of lifestyle parameters is selected from the group consisting of the nature of job, hours of work, sleeping habits, food habits, time spent on exercise, and the like.

The system 100 also includes a processor (not shown in figures) and a memory (not shown in figure). The processor is configured to cooperate with the memory to receive and process the set of pre-determined rules to obtain a set of system operating commands. Among other capabilities, the processor is configured to fetch and execute the set of predetermined rules stored in the memory to control modules/units of the system 100.

The computation unit 106 is configured to receive the values corresponding to the plurality of anthropometric parameters, and is further configured to compute the body mass index (BMI), diet calorie calculation (DCC), exercise calorie calculation (ECC), and the basal metabolic rate (BMR) of the user, based on the values of the plurality of anthropometric parameters.

The repository 108 is configured to cooperate with the user interface 102, the registration module 104, and the computation unit 106. The repository 108 is further configured to receive and store the values of the plurality of health parameters, values of the plurality of lifestyle parameters, and the computed values of the BMI, the DCC, the ECC, and the BMR.

The database 110 is configured to store a set of disease records, wherein each disease record, of the set of disease records, is associated with a standard range of values for the plurality of health parameters, a standard range of values for BMI, a standard range of values for DCC, a standard range of values for ECC, and a standard range of values for BMR. In an embodiment, the database 110 is configured to store a lookup table having prevention details corresponding to each of the disease record. In another embodiment, the database 110 also contains a list of common food along with their respective calorie contents.

The comparator and selector module 112 is configured to cooperate with the repository 108 and the database 110. The comparator and selector module 112 is further configured to compare:
the values of each of the plurality of health parameters with the standard range of values for each of the plurality of health parameters to select a first subset of disease records from the set of disease records;
the computed value of BMI and DCC with the standard range of values for BMI and DCC respectively to select a second subset of disease records from the set of disease records; and
the computed value of BMR and ECC with the standard range of values for BMR and ECC respectively to select a third subset of disease records from the set of disease records.

The risk prediction module 114 is configured to predict the risk of developing at least one disease, from the set of disease records, based on the first set of disease records, the second set of disease records, and the third set of disease records. In an exemplary embodiment, the risk prediction module 114 compares the first set of disease records, the second set of disease records, and the third set of disease records with respect to each other to predict/identify at least one disease that is present in the first set of disease records, the second set of disease records, and the third set of disease records.

In accordance with the present disclosure, the system 100 is configured to provide the user with prevention details pertaining to the identified and predicted at least one disease. In an embodiment, the system 100 further includes a crawler and extractor (not shown in figure) which is configured to crawl through the lookup table, stored in the database 110, and extract the prevention details corresponding to the predicted at least one disease. The extracted prevention details are presented to the user. In an embodiment, the prevention details, extracted by the crawler and extractor, are displayed on at least one handheld device, associated with the user, or on the publically launched viewable touch screen monitors which are communicatively coupled with the system 100. In another embodiment, the prevention details are in the form of text, audio, image, video, or any combination thereof.

In an embodiment, the system 100 includes a record generation module (not shown in figure). The record generation module is configured to generate a record corresponding to each user, wherein the record includes the value of the plurality of health parameters, values of the plurality of lifestyle parameters, the computed values of BMI, DCC, ECC and BMR, and at least one predicted disease. In another embodiment, the record corresponding to the user is accessed by a remote terminal, associated with at least one clinical pharmacist. The remote terminal is communicatively coupled to the system 100.

In another embodiment, the computation unit 106 includes a lifestyle assessment calculator, a diet calorie calculator, an exercise calorie calculator, and a daily calorie calculator.

In an embodiment, the daily calorie calculator is configured to determine the amount of calorie to be consumed by the user on a daily basis, by means of the daily calorie calculator, for maintaining good health. The amount of calorie to be consumed on a daily basis is calculated, by the computation unit 106, by means of the weight of the user, age of the user, and at least one lifestyle parameter of the plurality of lifestyle parameter.

In another embodiment, the system 100 allows the user to keep a track of the amount of calories consumed, i.e., by means of the diet calorie calculator, by providing the details of the food consumed, via the user interface 102, to the computation unit 106. The computation unit 106 is configured to determine the amount of calories consumed by accessing the calorie content of the food consumed from the database 110.

In still another embodiment, the system 100 allows the user to determine the amount of calories burnt by the user during workout, i.e., exercise. The exercise calorie calculator, of the computation unit 106, provides the user with amount of calories burnt while performing workout/exercise by allowing the user to provide the type of exercise performed, duration of exercise, and the weight of the user.

In a preferred embodiment, the computer implemented system 100 is used, by the user, for preventing diabetes. The system 100, with respect to this embodiment, is configured to generate awareness among the users with regards to diabetes and diabetic foot ulcers. The user is allowed to ascertain the risk of suffering from diabetes by providing aforementioned parameters.

In an embodiment, the system 100 also includes a clinical pharmacist intervention module (not shown in figures). The clinical pharmacist intervention module facilitates the clinical pharmacist to provide suggestions, medication details, lifestyle modification parameters, counseling to the user. Further, the clinical pharmacist intervention module also facilitates the clinical pharmacist to provide referrals of various health care professionals, diabetologist, dietician, podiatrist, cardiologist the like to the user. In another embodiment, the system 100 allows the user to provide details of their ongoing treatments and current diseases, thereby allowing the user to identify alternative treatments and/or medications available for the particular disease.

In an embodiment, the clinical pharmacist intervention module facilitates the clinical pharmacist to provide drug information services through hospital drug information centre to the user.

In another embodiment, the system 100 is supported by android platform, iOS platform, windows platform, and JAVA platform.

Further, the present disclosure envisages a computer implemented method 200 for providing health care management. The method 200 for providing health care management comprises the following steps:

At block 202, the method 200 includes the step of registering a user, using a registration module 104;

At block 204, the method 200 includes the step of receiving, from the user, values corresponding to a plurality of health parameters, a plurality of anthropometric parameters, and a plurality of lifestyle parameters;

At block 206, the method 200 includes the step of receiving, by a computation unit 106, the values corresponding to the plurality of anthropometric parameters;

At block 208, the method 200 includes the step of computing, by the computation unit 106, body mass index (BMI), Diet calorie calculation (DCC), exercise calorie calculation (ECC), and basal metabolic rate (BMR) of the user, based on the values of the plurality of anthropometric parameters;

At block 210, the method 200 includes the step of receiving, by a repository 108, the values of the plurality of health parameters, values of the plurality of lifestyle parameters, and the computed values of BMI, ECC, DCC, and BMR;

At block 212, the method 200 includes the step of storing, in the repository 108, the values of the plurality of health parameters, values of the plurality of lifestyle parameters, and the computed values of BMI, ECC, DCC, and BMR;

At block 214, the method 200 includes the step of storing a set of disease records, in a database 110, wherein each disease record, of the set of disease records, is associated with a standard range of values for the plurality of health parameters, a standard range of values for BMI, standard range of values for ECC, standard range of values for DCC, and a standard range of values for BMR;

At block 216, the method 200 includes the step of comparing, by a comparator and selector module 112, the values of each of the plurality of health parameters with the standard range of values for each of the plurality of health parameters, and selecting a first subset of disease records from the set of disease records;

At block 218, the method 200 includes the step of comparing, by the comparator and selector module 112, the computed value of BMI and DCC with the standard range of values for BMI and DCC respectively, and further selecting a second subset of disease records from the set of disease records;

At block 220, the method 200 includes the step of comparing, by the comparator and selector module 112, the computed value of BMR and ECC with the standard range of values for BMR and ECC respectively, and further selecting a third subset of disease records from the set of disease records; and

At block 222, the method 200 includes the step of predicting, by a risk prediction module 114, the risk of developing at least one disease, from the set of disease records, based on the first set of disease records, the second set of disease records, and the third set of disease records.

### TECHNICAL ADVANCES AND ECONOMICAL SIGNIFICANCE

The present disclosure described herein above has several technical advantages including, but not limited to, the realization of a computer implemented system for providing health care management that:
keeps the track of users BMI, DCC, ECC, and BMR;
assists the users in avoiding chronic diseases; and
is user friendly.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein.

Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A computer implemented system (100) for providing health care management, said system (100) comprising:
a registration module (104) adapted to register a user;
a user interface (102) configured to enable the user to access said system (100), and further configured to receive, from the user, values corresponding to a plurality of health parameters, a plurality of anthropometric parameters, and a plurality of lifestyle parameters;
a computation unit (106) configured to receive the values corresponding to said plurality of anthropometric parameters, and is further configured to compute body mass index (BMI), diet calorie calculation (DCC), exercise calorie calculation (ECC), and basal metabolic rate (BMR) of the user, based on the values of said plurality of anthropometric parameters;
a repository (108) configured to receive and store the values of said plurality of health parameters, values of said plurality of lifestyle parameters, and said computed values of BMI, DCC, ECC, and BMR;
a database (110) configured to store a set of disease records, wherein each disease record, of said set of disease records, is associated with a standard range of values for said plurality of health parameters, a standard range of values for BMI, a standard range of values for DCC, a standard range of values for ECC, and a standard range of values for BMR;
a comparator and selector module (112) configured to cooperate with said repository (108) and said database (110), and further configured to compare:
the values of each of said plurality of health parameters with the standard range of values for each of said plurality of health parameters to select a first subset of disease records from said set of disease records;
said computed value of BMI and DCC with said standard range of values for BMI and DCC respectively to select a second subset of disease records from said set of disease records; and
said computed value of BMR and ECC with said standard range of values for BMR and ECC respectively to select a third subset of disease records from said set of disease records.
a risk prediction module (114) configured to predict the risk of developing at least one disease, from said set of disease records, based on said first set of disease records, said second set of disease records, and said third set of disease records.

2. The system as claimed in claim 1, wherein said database (110) is configured to store a lookup table having prevention details corresponding to each of said disease record.

3. The system as claimed in claim 2, which includes a crawler and extractor configured to crawl through said lookup table and extract said prevention details corresponding to said predicted at least one disease.

4. The system as claimed in claim 3, wherein said prevention details are displayed on at least one handheld device, associated with said user, which is communicatively coupled with said system 100.

5. The system as claimed in claim 1, which includes a record generation module configured to generate a record corresponding to each of said user, wherein said record includes the values of said plurality of health parameters, values of said plurality of lifestyle parameters, said computed values of BMI, DCC, ECC, and BMR, and said at least one predicted disease.

6. The system as claimed in claim 5, wherein said record corresponding to the user is accessed by a remote terminal, associated with at least one clinical pharmacist, communicatively coupled to said system 100.

7. The system as claimed in claim 1, wherein said computation unit (106) includes a lifestyle assessment calculator, a diet calorie calculator, an exercise calorie calculator, and a daily calorie calculator.

8. The system as claimed in claim 2, wherein said prevention details are in the form of text, audio, image, video, or any combination thereof.

9. The system as claimed in claim 1, wherein said plurality of health parameters is selected from the group consisting of blood pressure, blood sugar level, haemoglobin level, glycosylated haemoglobin (HbA1c), lipid profile, serum creatinine level, proteinuria, and micro albuminuria.

10. A computer implemented method (200) for providing health care management, said method comprising the following steps:
registering a user, using a registration module;
receiving, from the user, values corresponding to a plurality of health parameters, a plurality of anthropometric parameters, and a plurality of lifestyle parameters;
receiving, by a computation unit, the values corresponding to said plurality of anthropometric parameters;
computing, by said computation unit, body mass index (BMI), diet calorie calculation (DCC), exercise calorie calculation (ECC), and basal metabolic rate (BMR) of the user, based on the values of said plurality of anthropometric parameters;
receiving, by a repository, the values of said plurality of health parameters, values of said plurality of lifestyle parameters, and said computed values of BMI, DCC, ECC, and BMR;
storing, in said repository, the values of said plurality of health parameters, values of said plurality of lifestyle parameters, and said computed values of BMI, DCC, ECC, and BMR;
storing a set of disease records, in a database, wherein each disease record, of said set of disease records, is associated with a standard range of values for said plurality of health parameters, a standard range of values for BMI, standard range of values for DCC, standard range of values for ECC, and a standard range of values for BMR;
comparing, by a comparator and selector module,
the values of each of said plurality of health parameters with the standard range of values for each of said plurality of health parameters, and selecting a first subset of disease records from said set of disease records;
said computed value of BMI and DCC with said standard range of values for BMI and DCC respectively, and selecting a second subset of disease records from said set of disease records; and
said computed value of BMR and ECC with said standard range of values for BMR and ECC respectively, and selecting a third subset of disease records from said set of disease records;
and
predicting, by a risk prediction module, the risk of developing at least one disease, from said set of disease records, based on said first set of disease records, said second set of disease records, and said third set of disease records.
